(19) United States
(12) Patent Application Publication
(10) Pub. No.: US 2026/0300981 A1
(43) Pub. Date: Oct. 1, 2026

(54) SYSTEMS AND METHODS FOR RESOURCE AUTHENTICATION AND VERIFICATION

(71) Applicant: BANK OF AMERICA CORPORATION, Charlotte, NC (US)

(72) Inventors: Zachary T. Lucchetti, Jacksonville, FL (US); Andrew C. Verdone, Riverview, FL (US); Amber Getty, Clayton, DE (US)

(73) Assignee: BANK OF AMERICA CORPORATION, Charlotte, NC (US)

(21) Appl. No.: 19/092,346

(22) Filed: Mar. 27, 2025

(51) Int. Cl. G06Q 20/40; G06Q 20/04; G06T 3/147; G06T 7/00

(52) U.S. Cl. CPC G06Q 20/4016; G06Q 20/042; G06T 3/147; G06T 7/001

(57) ABSTRACT

Systems, computer program products, and methods are described herein for authenticating and verifying financial instruments using image analysis and artificial intelligence. A system may receive a first image of a suspect financial instrument and a second image of a reference financial instrument. The system may preprocess the images by performing noise reduction, contrast adjustment, grayscale conversion, and geometric normalization. The images may then be overlaid allowing for manual or automated adjustments to transparency, brightness, and alignment. The images may be analyzed to identify discrepancies, such as alterations in printed text, signatures, or security features. The system may compute an exposure score based on the identified discrepancies and determine whether the suspect financial instrument is inauthentic or legitimate. The system may authorize or deny processing of the financial instrument based on a misrepresentation detection threshold.

### TECHNOLOGICAL FIELD

Example embodiments of the present disclosure relate to systems and methods for using advanced image processing techniques for authenticating and verifying resources, such as financial instruments.

### BACKGROUND

Distinguishing between legitimate and inauthentic checks can be challenging due to subtle alterations that may not be immediately apparent. Current methods for misrepresentation detection include side-by-side visual comparisons, where an associate manually inspects a suspect check against a reference image. Some misrepresentation prevention associates employ a structured scanning method, such as the “Z method,” in which they systematically examine the check in a particular pattern. While this approach provides a repeatable process, it is highly dependent on the associate's ability to detect minor inconsistencies. As a result, inauthentic checks may go unnoticed, leading to financial losses and security exposures.

Existing misrepresentation detection solutions may incorporate digital imaging tools, but they often require manual alignment, resizing, and feature comparison, which can be time-consuming and subject to human error. Furthermore, these methods do not always leverage automated techniques, such as AI-driven analysis, to assist in misrepresentation identification. Accordingly, there is a need for a more reliable and efficient image processing system that reduces reliance on manual review while improving the accuracy and speed of check authentication.

Applicant has identified a number of deficiencies and problems associated with resource authentication and verification. Many of these identified problems have been solved by developing solutions that are included in embodiments of the present disclosure, many examples of which are described in detail herein.

### BRIEF SUMMARY

Systems, methods, and computer program products are provided for authenticating and verifying a suspect financial instrument.

In one aspect, system for authenticating and verifying a suspect financial instrument is presented. The system comprising: an image acquisition and processing subsystem, wherein the image acquisition and processing subsystem is configured to: receive a first image and a second image, wherein the first image comprises an image of a suspect financial instrument and the second image comprises an image of a reference financial instrument; and automatically align the first image and the second image to facilitate comparative analysis; and an image analysis subsystem operatively coupled to the image acquisition and processing subsystem, wherein the image analysis is further configured to: overlay the first image onto the second image; receive a plurality of user inputs to adjust image settings associated with the first image and the second image in a predefined pattern to compare the first image and the second image; analyze, using an artificial intelligent (AI) model, the first image based on the comparison to identify discrepancies between the first image and the second image; determine an exposure score based on the identified discrepancies; determine whether the exposure score is greater than a misrepresentation detection threshold to determine whether the suspect financial instrument is inauthentic or legitimate; and authorize processing of the suspect financial instrument in an instance in which the exposure score is greater than the misrepresentation detection threshold.

In some embodiments, the image acquisition and processing subsystem is further configured to: pre-process the first image and the second image, wherein pre-processing comprises implement noise reduction, contrast enhancement, and normalization to standardize image quality.

In some embodiments, in aligning the first image and the second image, the image acquisition and processing subsystem is further configured to center the first image and the second image.

In some embodiments, in aligning the first image and the second image, the image acquisition and processing subsystem is further configured to scale the first image and the second image to a common resolution and dimensional framework based on predefined reference parameters.

In some embodiments, the exposure score represents a probabilistic measure of a likelihood that the first image is inauthentic.

In some embodiments, the plurality of user inputs is configured to adjust image settings to both the first image and the second image simultaneously.

In some embodiments, the plurality of user inputs is configured to adjust image settings to the first image and the second image independently.

In some embodiments, the image analysis subsystem is further configured to: automatically execute a plurality of actions to adjust image settings associated with the first image and the second image in a predefined pattern to compare the first image and the second image.

In some embodiments, in response to receiving each user input, the image analysis subsystem is further configured to: automatically execute a set of predefined transformations on the first image and the second image.

In some embodiments, the image analysis subsystem is further configured to: detect, using the AI model, discrepancies in the first image and the second image; and dynamically apply adjustments to image settings associated with the first image and the second image based on the detected discrepancies.

In another aspect, a method for authenticating and verifying a suspect financial instrument is presented. The method comprising: receiving, using an image acquisition and processing subsystem, a first image and a second image, wherein the first image comprises an image of a suspect financial instrument and the second image comprises an image of a reference financial instrument; automatically aligning, using the image acquisition and processing subsystem, the first image and the second image to facilitate comparative analysis; overlaying, using an image analysis subsystem, the first image onto the second image; receiving, using the image analysis subsystem, a plurality of user inputs to adjust image settings associated with the first image and the second image in a predefined pattern to compare the first image and the second image; analyzing, using an artificial intelligent (AI) model associated with the image analysis subsystem, the first image based on the comparison to identify discrepancies between the first image and the second image; determining, using the image analysis subsystem, an exposure score based on the identified discrepancies; determining, using the image analysis subsystem, whether the exposure score is greater than a misrepresentation detection threshold to determine whether the suspect financial instrument is inauthentic or legitimate; and authorizing, using the image analysis subsystem, processing of the suspect financial instrument in an instance in which the exposure score is greater than the misrepresentation detection threshold.

In yet another aspect, a computer program product for authenticating and verifying a suspect financial instrument is presented. The computer program product comprising a non-transitory computer-readable medium comprising code, that when executed, is configured to cause a processor to: receive a first image and a second image, wherein the first image comprises an image of a suspect financial instrument and the second image comprises an image of a reference financial instrument; and automatically align the first image and the second image to facilitate comparative analysis; overlay the first image onto the second image; receive a plurality of user inputs to adjust image settings associated with the first image and the second image in a predefined pattern to compare the first image and the second image; analyze, using an artificial intelligent (AI) model, the first image based on the comparison to identify discrepancies between the first image and the second image; determine an exposure score based on the identified discrepancies; determine whether the exposure score is greater than a misrepresentation detection threshold to determine whether the suspect financial instrument is inauthentic or legitimate; and authorize processing of the suspect financial instrument in an instance in which the exposure score is greater than the misrepresentation detection threshold.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for authenticating and verifying a suspect financial instrument, in accordance with an embodiment of the invention; and

FIG. 2 illustrates a process flow for authenticating and verifying a suspect financial instrument, in accordance with an embodiment of the invention.

### DETAILED DESCRIPTION

### Overview

Embodiments of the disclosure address the technical challenge of efficiently and accurately distinguishing between legitimate and inauthentic checks. Traditional manual inspection methods are prone to human error, require extensive time, and lack automated assistance for detecting subtle discrepancies. Misrepresentation prevention associates often compare a suspect check with a reference check side by side, relying on visual inspection to identify variations in check stock, security features, or handwriting. This process is not only labor-intensive but also susceptible to inconsistencies in detection.

Embodiments of the disclosure provide a system that automates and improves the check verification process by allowing an associate to overlay a suspect check image onto a reference image. The system automatically aligns, centers, and scales the images, ensuring that corresponding features are positioned for direct comparison. A transparency tool enables the user to adjust the visibility of the overlaid images, allowing both checks to be viewed simultaneously. By using this approach, subtle alterations become more apparent, reducing the likelihood of inauthentic checks being overlooked. In some embodiments, AI-based analysis may be incorporated to assist in identifying discrepancies, such as variations in font, handwriting, or security features. The system may provide an automated misrepresentation assessment, reducing the reliance on human judgment and increasing detection accuracy.

As such, embodiments of the disclosure provide a structured and technology-driven approach to misrepresentation detection, offering several benefits in real-world applications. By automating the alignment and transparency-based comparison of check images, the system reduces the number of manual steps required for check verification, increasing efficiency. The overlay method makes subtle discrepancies more visible, decreasing the likelihood of inauthentic checks being approved. Automating the check verification process reduces the need for extended manual review, conserving time and computational resources that would otherwise be spent on error correction or re-evaluation. The system automatically sizes and aligns checks upon input, eliminating the need for manual image manipulation, which reduces processing time and human effort. In embodiments where AI is used, the system can further assist by detecting anomalies and highlighting potential misrepresentation indicators, reducing the cognitive load on human reviewers.

Furthermore, embodiments of the disclosure provide several measurable technical advantages. For instance, the automation of image alignment and overlay comparison reduces the time required for check verification. By providing a structured, computerized method that minimizes the variability associated with human judgment, the system allows for reduced dependence on human analysis. Additionally, the overlay-based comparison method highlights alterations that may not be visible in a side-by-side review. Lastly, the ability to integrate AI for misrepresentation detection further strengthens check authentication processes by identifying irregularities beyond human perception. By leveraging image processing and AI-driven analysis, embodiments of the disclosure provide a more efficient, accurate, and reliable solution for authenticating financial documents while reducing manual effort and resource consumption

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

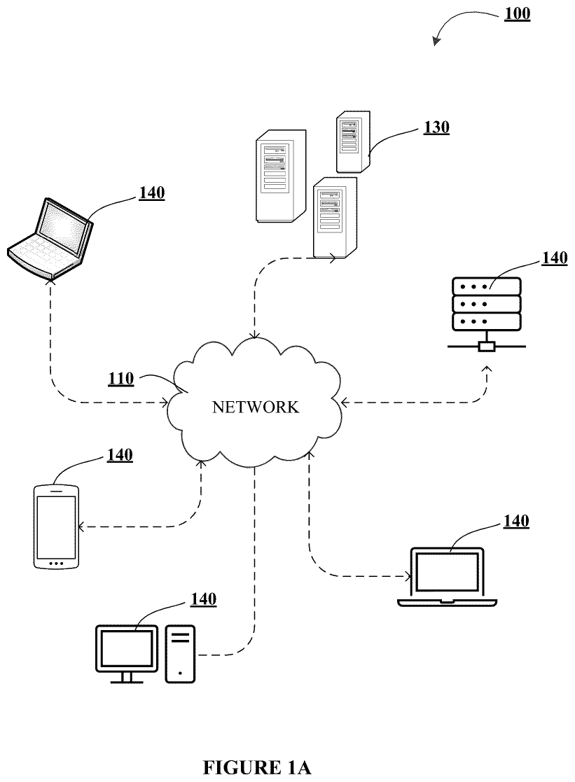

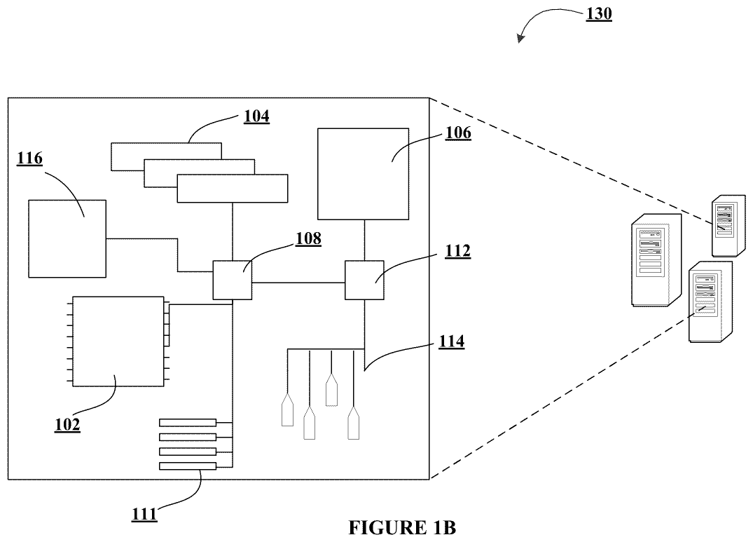

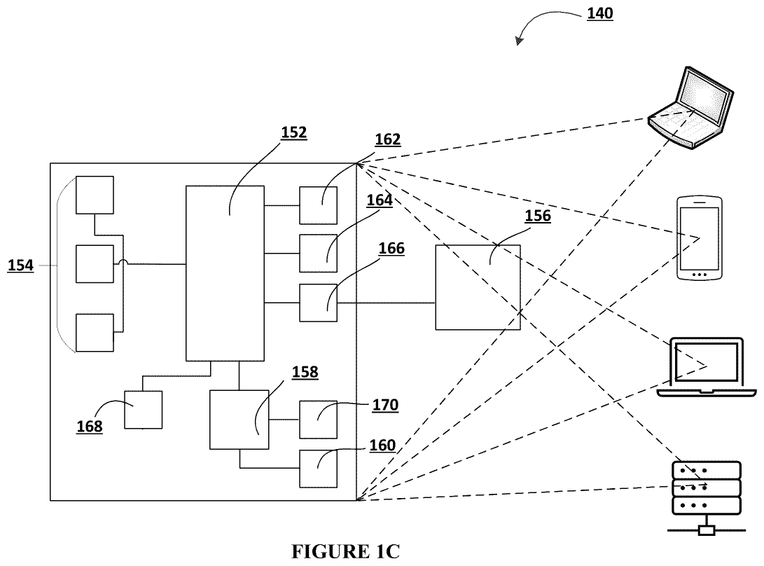

FIGS. 1A-1C illustrate technical components of an exemplary distributed computing environment 100 for authenticating and verifying a suspect financial instrument, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may be configured to perform various operations related to receiving, processing, analyzing, and determining the authenticity of financial documents by leveraging its subsystems (e.g., image acquisition and processing subsystem and/or image analysis subsystem). The computing environment enables real-time or asynchronous communication between the system 130 and end-point devices 140, allowing for distributed processing, remote access, and seamless data exchange over network 110. The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

For instance, the image acquisition and processing subsystem may be configured to receive and preprocess images of financial instruments to facilitate comparative analysis. The image acquisition and processing subsystem may obtain a first image representing a suspect financial instrument and a second image representing a reference financial instrument from an image capture device, document scanning system, or external data source. To standardize the images, the image acquisition and processing subsystem may perform pre-processing operations such as noise reduction, contrast enhancement, grayscale conversion, and geometric normalization. These processes may improve feature visibility, remove artifacts, and ensure uniformity for analysis. The image acquisition and processing subsystem may further implement automatic alignment, centering, and scaling using feature matching techniques to position document elements accurately and normalize resolution differences. Once preprocessing is complete, the image acquisition and processing subsystem may transmit the processed images to the image analysis subsystem for overlaying, comparison, and discrepancy detection. The image acquisition and processing subsystem may also communicate with storage components to log image metadata, processing parameters, and alignment transformations for auditing and future reference. In some embodiments, the image acquisition and processing subsystem may integrate with external databases to retrieve reference financial instrument images for comparative verification.

The image analysis subsystem may be configured to overlay, compare, and analyze the first image and the second image to identify discrepancies indicative of unauthorized modifications. In this regard, the image analysis subsystem may receive preprocessed images from the image acquisition and processing subsystem and apply various overlay techniques, including static, transparency-based, differential, and region-based overlays, to facilitate structured comparative analysis. Users may adjust image settings such as transparency, brightness, contrast, zoom level, and alignment either simultaneously or independently for each image. The image analysis subsystem may also implement predefined comparison patterns and automated transformations to streamline the analysis process. In some embodiments, an automated layer-shuffling mechanism may dynamically switch image visibility, and region-specific processing may isolate targeted sections for focused examination. Once adjustments are completed, the image analysis subsystem may extract document features and transmit them for classification, exposure scoring, and final determination, while also enabling users to annotate, store, and generate assessment reports.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

In the context of the invention, system 130 may execute misrepresentation detection workflows, including image acquisition, pre-processing, overlay comparison, and AI-driven discrepancy analysis. The processor 102 and memory 104 of system 130 may be configured to store and execute machine learning models that analyze images of financial instruments and classify detected discrepancies. Additionally, the storage device 106 may be used to maintain a historical database of processed financial instruments, which may serve as a reference for ongoing misrepresentation detection. The integration of high-speed interfaces 108 ensures that resource-intensive image processing tasks, such as neural network inference and pattern recognition, are executed efficiently.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

In specific embodiments, the end-point device(s) 140 may be configured to receive the first image, representing a suspect financial instrument, from a user through various input mechanisms. In some embodiments, the end-point device 140 may include an image capture component, such as a built-in or external camera, scanner, or mobile imaging system, to directly capture an image of the financial instrument. The captured image may then be transmitted to the system 130 over network 110 for processing and analysis. Alternatively, the user may upload a pre-existing digital image of the financial instrument from local storage on the end-point device 140. In some implementations, the end-point device 140 may provide an interactive interface that allows users to preview, crop, or adjust the captured image before submitting it for verification. The communication interface 158 of the end-point device 140 may facilitate secure transmission of the image to the system 130, employing encryption protocols to maintain data integrity and confidentiality. Once received, the system 130 may initiate the authentication and verification process by forwarding the image to the image acquisition and processing subsystem.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

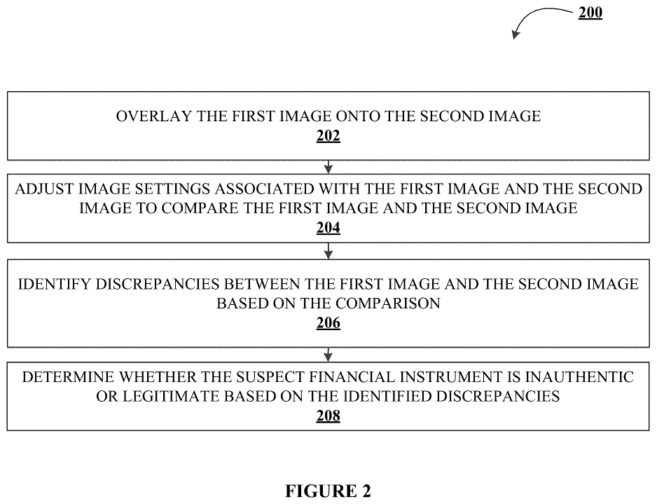

FIG. 2 illustrates a process flow 200 for authenticating and verifying a suspect financial instrument, in accordance with an embodiment of the invention. As shown in block 202, the process flow includes overlaying the first image onto the second image. In this regard, an image acquisition and processing subsystem may be configured to receive the first image, corresponding to a suspect financial instrument, and the second image, corresponding to a reference financial instrument. Once received, the image acquisition and processing subsystem may automatically align and scale the first image and the second image before overlaying them. In this regard, the image acquisition and processing subsystem may use predefined reference parameters or machine learning-based geometric transformations to perform alignment. Techniques such as affine transformations, homography-based warping, or keypoint detection algorithms may be used to establish correspondences between the images, correcting for distortions, variations in scanning angles, or differences in document dimensions. The automated alignment process may reduce reliance on manual intervention while maintaining precision in the overlay operation.

Additionally, the image acquisition and processing subsystem may apply pre-processing techniques to the images (e.g., the first image and the second image) before overlaying the images. The pre-processing techniques may include noise reduction to mitigate artifacts introduced during image capture, contrast normalization to adjust pixel intensity distribution for improved feature distinction, and edge detection to identify structural components such as borders, printed characters, and embedded security marks. Color conversion, such as transforming images into a standardized grayscale or color space, may also be implemented for uniform comparison. These pre-processing steps may optimize the images for more accurate comparative analysis.

Once aligned, the image analysis subsystem may be configured to process the images to facilitate comparative analysis by aligning, centering, and overlaying them. The overlaying operation may be performed such that corresponding features of the financial instruments, such as text, numerical values, security elements, or handwritten signatures, are positioned for direct visual or computational comparison. The overlaying step allows for the detection of structural, graphical, and compositional differences between the suspect and reference financial instruments, which may be indicative of unauthorized alterations.

The overlaying operation may be implemented using various comparative approaches. A static overlay may be used where the first image is directly superimposed on the second image without modification. A transparency-based overlay may allow adjustable opacity levels, enabling simultaneous viewing of both images with varying visibility settings. A differential overlay may involve pixel-wise subtraction or computational comparisons to highlight areas of discrepancy. In some implementations, a region-based overlay may isolate specific areas of interest, such as signature fields, security elements, or numerical values, and overlay them separately for targeted examination.

In certain embodiments, the overlaying process may be dynamic, allowing for automated or user-directed adjustments to the alignment and positioning of the images. These adjustments may be necessary to account for inconsistencies in scanning, document warping, or minor positional deviations. The system may allow real-time modifications to improve the accuracy of the overlay, facilitating more precise comparisons.

As shown in block 204, the process flow includes adjusting image settings associated with the first image and the second image to compare the first image and the second image. The image analysis subsystem may receive user input to modify various image parameters, such as transparency, brightness, contrast, zoom level, or alignment adjustments, to facilitate a more detailed comparative analysis. These adjustments may allow for improved visual differentiation between the first image and the second image, aiding in the identification of inconsistencies. The user may be able to apply modifications simultaneously to both images or independently to each image. By allowing independent control, the system may accommodate situations where one image requires different adjustments due to variations in scanning quality, lighting conditions, or print resolution.

In some embodiments, the image analysis subsystem may execute a predefined sequence of image transformations in response to user input. The predefined sequence may be selected from a set of available comparison patterns, which may include sequential transparency adjustments, alternating overlays, or automated zooming into predefined regions of interest such as signatures, security features, or numerical fields. This approach may reduce the need for multiple manual inputs while ensuring that the images are processed in a consistent manner. The user may select a predefined pattern before initiating the comparison, allowing the image analysis subsystem to execute a structured and repeatable sequence of transformations without requiring additional user intervention.

In addition to manual input, the image analysis subsystem may incorporate automated adjustments based on detected discrepancies between the first image and the second image. The image analysis subsystem may analyze initial differences and suggest or automatically apply adjustments, such as increasing the contrast in specific regions, refining alignment, or selectively modifying the transparency of particular image areas. This automated approach may assist in improving efficiency and accuracy in detecting unauthorized alterations in the suspect financial instrument.

In some implementations, the image analysis subsystem may include an automated layer-shuffling mechanism that dynamically switches the visibility of the first image and the second image in a predefined sequence. This process may alternate the display of the images at varying opacities or in rapid succession, allowing discrepancies to become more visually apparent. The image analysis subsystem may further enable the user to interactively toggle between different processing modes, such as a differential mode that highlights only the variations between the two images or a side-by-side mode that presents both images simultaneously for comparison.

As shown in block 206, the process flow includes identifying discrepancies between the first image and the second image based on the comparison. The image analysis subsystem may analyze the overlaid images to detect variations between the first image, representing the suspect financial instrument, and the second image, representing the reference financial instrument. The identification of discrepancies may involve detecting differences in structural features, printed text, numerical values, handwriting characteristics, graphical elements, or embedded security features. These discrepancies may indicate unauthorized modifications, tampering, or inauthenticity.

In some embodiments, an artificial intelligence (AI) model may be used to automate the discrepancy detection process. The AI model may be trained on a dataset of financial instruments, allowing it to recognize common indicators of document alterations. The model may use feature extraction techniques to compare key elements of the first image and the second image, including, (i) textual inconsistences, such as font variations, misalignment, or alterations in printed values, (ii) signature mismatches, including variations in stroke pressure, curvature, or size, (iii) security feature anomalies, such as missing watermarks, distortions in microprinting, or inconsistencies in holographic elements, (iv) structural deviations, including changes in check stock, formatting variations, or differences in the positioning of printed elements, and/or the like.

In some embodiments, an artificial intelligence (AI) model may be used to automate the discrepancy detection process. The AI model may be implemented as a machine learning-based image analysis engine (a computational module, system, or software component configured to perform specialized processing tasks) trained to identify variations between financial instruments. The AI model may be trained using supervised learning, unsupervised learning, or a combination thereof. During supervised learning, a dataset of financial instruments, including both legitimate and altered examples, may be used to develop a classification model. The training data may include labeled examples of common misrepresentation modifications, such as altered payee names, modified check amounts, or forged signatures. The AI model may be trained to recognize differences between authentic and suspect financial instruments by analyzing feature representations extracted from the training data.

The AI model may utilize convolutional neural networks (CNNs), recurrent neural networks (RNNs), transformer-based architectures, or a hybrid approach to perform feature extraction and classification. A CNN-based architecture may be particularly suited for processing document images due to its ability to detect spatial hierarchies in patterns. The CNN model may include multiple layers of convolutional filters, pooling layers, and fully connected layers to process image data and extract distinguishing features. These features may represent pixel intensity variations, edge patterns, texture differences, or localized anomalies. The final layer of the CNN model may output a classification score or a probability distribution indicating the likelihood of the suspect financial instrument being inauthentic.

In some implementations, the AI model may incorporate an anomaly detection algorithm that does not require predefined labels. An unsupervised learning approach, such as an autoencoder or generative adversarial network (GAN)-based model, may be used to learn a representation of genuine financial instruments. The AI model may generate a latent feature representation of the reference financial instrument and compare it with the suspect financial instrument. Discrepancies in the latent space may indicate the presence of alterations, even if the specific nature of the modification is not known beforehand. This approach may be useful in detecting new types of misrepresentation not explicitly represented in the training data.

The AI model may apply computer vision techniques, such as optical character recognition (OCR), edge detection, and feature matching, to compare textual and graphical elements between the first image and the second image. OCR may be used to extract printed and handwritten text from both images, enabling a direct comparison of payee names, check amounts, signatures, and serial numbers. Edge detection algorithms, such as Canny edge detection or Sobel filtering, may be applied to identify variations in document borders, security features, or background textures. Feature matching algorithms, including scale-invariant feature transform (SIFT), speeded-up robust features (SURF), or ORB (oriented FAST and rotated BRIEF), may be used to compare keypoints between the two images and highlight regions where inconsistencies are detected.

The discrepancy identification process may further include region-specific analysis, wherein the AI model isolates specific areas of interest for focused comparison. The system may segment the financial instrument into predefined regions, such as the payee field, numerical amount field, signature field, endorsement section, and security watermark area. The AI model may apply different feature extraction and classification techniques to each region, optimizing the detection process for various types of modifications. For example, handwriting recognition techniques may be applied specifically to the signature field, while pixel-wise comparison techniques may be used in security feature areas.

In some embodiments, the discrepancy identification process may incorporate confidence scoring, wherein each detected difference is assigned a probability score indicating the likelihood that the variation represents an unauthorized modification. The AI model may generate a ranked list of detected discrepancies, sorted by confidence level, allowing the system to prioritize the most significant anomalies for further processing. The confidence score may be computed based on factors such as the magnitude of the detected discrepancy, the historical accuracy of the AI model in identifying similar variations, and statistical deviation from expected patterns.

As shown in block 208, the process flow includes determining whether the suspect financial instrument is inauthentic or legitimate based on the identified discrepancies. The image analysis subsystem may determine an exposure score based on the discrepancies identified between the first image and the second image. The exposure score may represent a probabilistic measure of the likelihood that the suspect financial instrument has been altered or is otherwise inauthentic. The image analysis subsystem may compute the exposure score by analyzing multiple factors, including the type, location, and severity of the detected discrepancies. Each discrepancy may be assigned a weight based on its relevance to financial instrument verification. For example, discrepancies in security features or check amounts may contribute more significantly to the exposure score than minor variations in background noise. The system may compare the exposure score to a predefined misrepresentation detection threshold to classify the suspect financial instrument as either inauthentic or legitimate. The threshold may be dynamically adjusted based on historical misrepresentation detection patterns, user-defined parameters, or exposure assessment algorithms. In some embodiments, the system may implement a tiered classification approach, where financial instruments are categorized into multiple levels of authenticity exposure, such as: (i) legitimate, where the exposure score falls below a first threshold, indicating no significant discrepancies, (ii) potentially altered, where the exposure score falls between a first threshold and a second threshold, requiring further review, or (iii) likely inauthentic, where the exposure score exceeds the second threshold, triggering an automatic flag for rejection or escalation.

To improve decision accuracy, the system may apply machine learning-based classification models trained on historical financial instrument data. These models may leverage supervised learning techniques, where labeled data from past verification results are used to optimize the threshold determination process. In some implementations, an ensemble learning approach may be used, combining multiple classifiers such as decision trees, support vector machines (SVMs), and deep neural networks to refine the classification outcome.

The final determination may be reported to a user via a graphical interface, an API response, or a notification system integrated with financial processing infrastructure. The report may include a summary of detected discrepancies, the computed exposure score, and the classification result. In some implementations, the system may generate a confidence report that provides contextual information regarding the reliability of the determination, including statistical confidence levels and comparison against past verification cases.

If the exposure score exceeds the misrepresentation detection threshold, the system may trigger an automated response to authorize or deny processing of the suspect financial instrument. The response may include: (i) automatic rejection of the financial instrument, where the system transmits a denial notification to a payment processor or financial institution, (ii) flagging the instrument for manual review, where additional verification steps may be performed by misappropriation prevention personnel, or (iii) requesting additional data, where the system may prompt for secondary authentication, such as cross-referencing external databases or requesting verification from the issuing institution.

In some embodiments, the system may integrate with existing misappropriation detection frameworks, allowing institutions to configure custom processing rules based on organizational policies. The system may also maintain a historical misappropriation detection database, where past exposure scores and verification results are logged to refine future classification accuracy and assist in predictive misappropriation detection models.

Once the classification determination is completed and the processing decision is made, the system may store the results in a database. The stored data may include raw image files, identified discrepancies, computed exposure scores, and final determination labels. This historical data may be used to train subsequent AI models, improve misappropriation detection accuracy, and provide supervisory records, where applicable.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for authenticating and verifying a suspect financial instrument, the system comprising:
an image acquisition and processing subsystem, wherein the image acquisition and processing subsystem is configured to:
receive a first image and a second image, wherein the first image comprises an image of a suspect financial instrument and the second image comprises an image of a reference financial instrument; and
automatically align the first image and the second image to facilitate comparative analysis; and
an image analysis subsystem operatively coupled to the image acquisition and processing subsystem, wherein the image analysis is further configured to:
overlay the first image onto the second image;
receive a plurality of user inputs to adjust image settings associated with the first image and the second image in a predefined pattern to compare the first image and the second image;
analyze, using an artificial intelligent (AI) model, the first image based on the comparison to identify discrepancies between the first image and the second image;
determine an exposure score based on the identified discrepancies;
determine whether the exposure score is greater than a misrepresentation detection threshold to determine whether the suspect financial instrument is inauthentic or legitimate; and
authorize processing of the suspect financial instrument in an instance in which the exposure score is greater than the misrepresentation detection threshold.

2. The system of claim 1, wherein the image acquisition and processing subsystem is further configured to:
pre-process the first image and the second image, wherein pre-processing comprises implement noise reduction, contrast enhancement, and normalization to standardize image quality.

3. The system of claim 1, wherein, in aligning the first image and the second image, the image acquisition and processing subsystem is further configured to center the first image and the second image.

4. The system of claim 1, wherein, in aligning the first image and the second image, the image acquisition and processing subsystem is further configured to scale the first image and the second image to a common resolution and dimensional framework based on predefined reference parameters.

5. The system of claim 1, wherein the exposure score represents a probabilistic measure of a likelihood that the first image is inauthentic.

6. The system of claim 1, wherein the plurality of user inputs is configured to adjust image settings to both the first image and the second image simultaneously.

7. The system of claim 1, wherein the plurality of user inputs is configured to adjust image settings to the first image and the second image independently.

8. The system of claim 1, wherein the image analysis subsystem is further configured to:
automatically execute a plurality of actions to adjust image settings associated with the first image and the second image in a predefined pattern to compare the first image and the second image.

9. The system of claim 1, wherein, in response to receiving each user input, the image analysis subsystem is further configured to:
automatically execute a set of predefined transformations on the first image and the second image.

10. The system of claim 1, wherein the image analysis subsystem is further configured to:
detect, using the AI model, discrepancies in the first image and the second image; and
dynamically apply adjustments to image settings associated with the first image and the second image based on the detected discrepancies.

11. A method for authenticating and verifying a suspect financial instrument, the method comprising:
receiving, using an image acquisition and processing subsystem, a first image and a second image, wherein the first image comprises an image of a suspect financial instrument and the second image comprises an image of a reference financial instrument;
automatically aligning, using the image acquisition and processing subsystem, the first image and the second image to facilitate comparative analysis;
overlaying, using an image analysis subsystem, the first image onto the second image;
receiving, using the image analysis subsystem, a plurality of user inputs to adjust image settings associated with the first image and the second image in a predefined pattern to compare the first image and the second image;
analyzing, using an artificial intelligent (AI) model associated with the image analysis subsystem, the first image based on the comparison to identify discrepancies between the first image and the second image;
determining, using the image analysis subsystem, an exposure score based on the identified discrepancies;
determining, using the image analysis subsystem, whether the exposure score is greater than a misrepresentation detection threshold to determine whether the suspect financial instrument is inauthentic or legitimate; and
authorizing, using the image analysis subsystem, processing of the suspect financial instrument in an instance in which the exposure score is greater than the misrepresentation detection threshold.

12. The method of claim 11, wherein the method further comprises:
pre-processing, using the image acquisition and processing subsystem, the first image and the second image, wherein pre-processing comprises implement noise reduction, contrast enhancement, and normalization to standardize image quality.

13. The method of claim 11, wherein aligning the first image and the second image further comprises scaling the first image and the second image to a common resolution and dimensional framework based on predefined reference parameters.

14. The method of claim 11, wherein the exposure score represents a probabilistic measure of a likelihood that the first image is inauthentic.

15. The method of claim 11, wherein the plurality of user inputs is configured to adjust image settings to both the first image and the second image simultaneously.

16. The method of claim 11, wherein the plurality of user inputs is configured to adjust image settings to the first image and the second image independently.

17. The method of claim 11, wherein the method further comprises:
automatically executing, using the image analysis subsystem, a plurality of actions to adjust image settings associated with the first image and the second image in a predefined pattern to compare the first image and the second image.

18. A computer program product for authenticating and verifying a suspect financial instrument, the computer program product comprising a non-transitory computer-readable medium comprising code, that when executed, is configured to cause a processor to:
receive a first image and a second image, wherein the first image comprises an image of a suspect financial instrument and the second image comprises an image of a reference financial instrument; and
automatically align the first image and the second image to facilitate comparative analysis;
overlay the first image onto the second image;
receive a plurality of user inputs to adjust image settings associated with the first image and the second image in a predefined pattern to compare the first image and the second image;
analyze, using an artificial intelligent (AI) model, the first image based on the comparison to identify discrepancies between the first image and the second image;
determine an exposure score based on the identified discrepancies;
determine whether the exposure score is greater than a misrepresentation detection threshold to determine whether the suspect financial instrument is inauthentic or legitimate; and
authorize processing of the suspect financial instrument in an instance in which the exposure score is greater than the misrepresentation detection threshold.

19. The computer program product of claim 18, wherein the code, when executed, further causes the processor to:
pre-process the first image and the second image, wherein pre-processing comprises implement noise reduction, contrast enhancement, and normalization to standardize image quality.

20. The computer program product of claim 18, wherein aligning the first image and the second image further comprises scaling the first image and the second image to a common resolution and dimensional framework based on predefined reference parameters.
